(19) United States
(12) Patent Application Publication
(10) Pub. No.: US 2017/0123037 A1
(43) Pub. Date: May 4, 2017

(54) METHOD FOR CALCULATING ANGULAR POSITION OF PERIPHERAL DEVICE WITH RESPECT TO ELECTRONIC APPARATUS, AND PERIPHERAL DEVICE WITH FUNCTION OF THE SAME

(71) Applicant: Samsung Electronics Co., Ltd., Suwon-si (KR)

(72) Inventors: Sun-woo KIM, Suwon-si (KR); Hyun-koo KANG, Yongin-si (KR); Jin LEE, Suwon-si (KR)

(73) Assignee: Samsung Electronics Co., Ltd., Suwon-si (KR)

(21) Appl. No.: 15/338,887

(22) Filed: Oct. 31, 2016

(30) Foreign Application Priority Data
Nov. 4, 2015 (KR) 10-2015-0154752

(51) Int. Cl. G01S 3/802; H04R 1/32; H04R 29/00

(52) U.S. Cl. CPC G01S 3/802; H04R 29/001; H04R 1/323; H04R 2499/15

(57) ABSTRACT

A method of calculating an angular position of a peripheral device with respect to an electronic apparatus, a peripheral device, and an electronic apparatus are provided. The method includes receiving sounds, by the peripheral device, from each of a pair of loudspeakers provided in the electronic apparatus; and calculating, by the peripheral device, an angular position of the peripheral device with respect to a predetermined direction, based on a time difference between respective points of time in receiving the sounds from each loudspeaker.

### CROSS-REFERENCE TO RELATED APPLICATIONS

This application claims the priority benefit of Korean Application No. 10-2015-0154752, filed Nov. 4, 2015, in the Korean Intellectual Property Office, the disclosure of which is incorporated herein by reference.

### BACKGROUND

1. Field

Apparatuses and methods consistent with the exemplary embodiments relate to a method for calculating an angular position of a peripheral device with respect to an electronic apparatus and a peripheral device with a function of the same, and more particularly to a method for calculating a relative angular position of a remote controller, a loudspeaker or the like peripheral device with respect to an electronic apparatus such as a television (TV) and the peripheral device with a function of the same.

2. Description of the Related Art

A TV or the like electronic apparatus is typically used at a stationary position in a room, and a remote controller, a loudspeaker or the like device is used as a peripheral device together with the TV. For example, the peripheral device performs a passive function like a loudspeaker that receives and reproduces a sound signal from the TV, or an active function like a remote controller that controls the TV.

When the electronic apparatus is installed or while the electronic apparatus is in use, there may be a need of determining the position of the peripheral device. For example, the remote controller is frequently used by a user for channel change, volume control, etc. with respect to the stationary electronic apparatus. In general, a user uses the remote controller when necessary and puts it anywhere after use. Therefore, a user is likely to forget where they put the remote controller, and it is thus inconvenient for a user to find the remote controller everywhere to use it again.

For example, in case of the loudspeaker as the peripheral device of the TV, a plurality of loudspeakers is positioned after stationarily installing the TV on a wall. Although the same TV and loudspeakers are applied, the layout of them may be varied depending on the space shapes of the room. FIG. 1 is a detailed view for explaining a relationship between the positions of the loudspeakers and the position of the TV, in which the three loudspeakers 31˜33 are arranged.

To make a user feel a stereophonic sound with multi-channel sounds, setting values about the positions of the loudspeakers corresponding to the respective channels have to be input to the TV. In FIG. 1, a second loudspeaker 32 is arranged in front of a TV 20 and forms an angle of 0° with a frontward direction, a first loudspeaker 31 is arranged at the left side of the TV 20 and forms an angle of 30° with the frontward direction, and a third loudspeaker 33 is arranged at the right side of the TV 20 and forms an angle of 30° with the frontward direction. After a user sets the layout of loudspeakers 31˜33, they have to input the positions of the respective loudspeakers 31˜33 as the setting values to the TV 20. Based on the positions of the respective loudspeakers 31˜33, the TV controls a method of reproducing a sound while reproducing the sound. For example, in a case where a certain sound is first reproduced at the right side and then sequentially reproduced at the center and the left side as if a certain object moves from the right side to the left side, the TV 20 controls the third loudspeaker 33, the second loudspeaker 32 and the first loudspeaker 31 to reproduce the sound in sequence based on the layout of the first to third loudspeakers 31˜33.

Like the, various peripheral devices need to make the electronic apparatus know their relative positions to the electronic apparatus. However, a conventional method of setting positions of peripheral devices has proposed only a method in which a user has to manually input the positions of the peripheral device to the electronic apparatus. In such a conventional method, a user makes an input depending on their own sense even though the input of the position has to be as precise as possible in the case where the peripheral device is the loudspeaker as shown in FIG. 1, and the input is repeated for the respective loudspeakers 31˜33. Therefore, it is very inconvenient for a user, and the input of the position is not precise. Besides, in the case of the peripheral device, the position of which often varies like the remote controller by way of example, it is impossible to know the position of the remote controller if a user cannot remember the position of the remote controller.

Accordingly, there is a need of making the electronic apparatus automatically determine and set the position of the peripheral device, or allowing a user to easily know the position of the peripheral device.

### SUMMARY

Additional aspects and/or advantages will be set forth in part in the description which follows and, in part, will be apparent from the description, or may be learned by practice of the invention.

In accordance with an exemplary embodiment, there is provided a method of calculating an angular position of a peripheral device with respect to an electronic apparatus, the method comprising: by the peripheral device, receiving sounds from each of a pair of loudspeakers provided in the electronic apparatus; and by the peripheral device, calculating an angular position of the peripheral device with respect to a predetermined direction, based on a receiving time difference between respective points of time taken in receiving the sounds from each loudspeaker.

The sound may include ultrasonic waves.

The sound may include an identification signal of each loudspeaker.

The calculating the angular position may include calculating the angular position based on an angle of an asymptote of a hyperbola formed by defining the positions of the pair of loudspeakers as positions of a pair of focal points and a distance corresponding to the receiving time difference as a distance difference.

The peripheral device may include a matching table of a database where the angles of the asymptote are previously tabulated corresponding to a plurality of the distance differences or a plurality of the receiving time differences.

The method may further include, by the peripheral device, transmitting the calculated angular position to the electronic apparatus.

The method may further include, by the electronic apparatus, outputting information about the angular position.

In accordance with another exemplary embodiment, there is provided a peripheral device capable of calculating its relative angular position with respect to an electronic apparatus, the peripheral device comprising: a sound receiver configured to receive sounds from each of a pair of loudspeakers provided in the electronic apparatus; and a calculator configured to calculate the angular position with respect to a predetermined direction, based on a receiving time difference between respective points of time taken in receiving the sounds from each loudspeaker in the sound receiver.

The sound may include ultrasonic waves.

The sound may include an identification signal of each loudspeaker.

The calculator may calculate the angular position based on an angle of an asymptote of a hyperbola formed by defining the positions of the pair of loudspeakers as positions of a pair of focal points and a distance corresponding to the receiving time difference as a distance difference.

The peripheral device may further include a storage configured to comprise a matching table of a database where the angles of the asymptote are previously tabulated corresponding to a plurality of distance differences or a plurality of the receiving time differences, wherein the calculator looks up the matching table to determine the angular position.

The peripheral device may further include a transmitter configured to transmit the angular position to the electronic apparatus.

In accordance with yet another exemplary embodiment, there is provided a method of calculating an angular position of a peripheral device with respect to an electronic apparatus, the method comprising: by the electronic apparatus, receiving sounds in at least two positions from the peripheral device; and by the electronic apparatus, calculating an angular position of the peripheral device with respect to a predetermined direction, based on a receiving time difference between respective points of time taken in receiving the sounds in the at least two positions.

The sound may include ultrasonic waves.

The calculating the angular position may include calculating the angular position based on an angle of an asymptote of a hyperbola formed by defining the positions of the pair of loudspeakers as positions of a pair of focal points and a distance corresponding to the receiving time difference as a distance difference.

The electronic apparatus may include a matching table of a database where the angles of the asymptote are previously tabulated corresponding to a plurality of distance differences or a plurality of the receiving time differences.

The method may further include, by the electronic apparatus, outputting information about the angular position.

In accordance with still another exemplary embodiment, there is provided an electronic apparatus capable of calculating an angular position of a peripheral device, the electronic apparatus comprising: a pair of sound receivers configured to be respectively arranged at different positions; and a calculator configured to calculate the angular position with respect to a predetermined direction of the peripheral device, based on a receiving time difference between respective points of time taken in receiving sounds in each of the sound receivers.

The sound may include ultrasonic waves.

The calculator may calculate the angular position based on an angle of an asymptote of a hyperbola formed by defining the positions of the pair of loudspeakers as positions of a pair of focal points and a distance corresponding to the receiving time difference as a distance difference.

The electronic may further include a storage configured to comprise a matching table of a database where the angles of the asymptote are previously tabulated corresponding to a plurality of distance differences or a plurality of the receiving time differences, wherein the calculator looks up the matching table to determine the angular position.

The electronic apparatus may further include an output unit to output information about the calculated angular position.

### BRIEF DESCRIPTION OF THE DRAWINGS

These and/or other aspects and advantages will become apparent and more readily appreciated from the following description of the embodiments, taken in conjunction with the accompanying drawings.

FIG. 1 is a view for explaining a relative position between an electronic apparatus and a peripheral device.

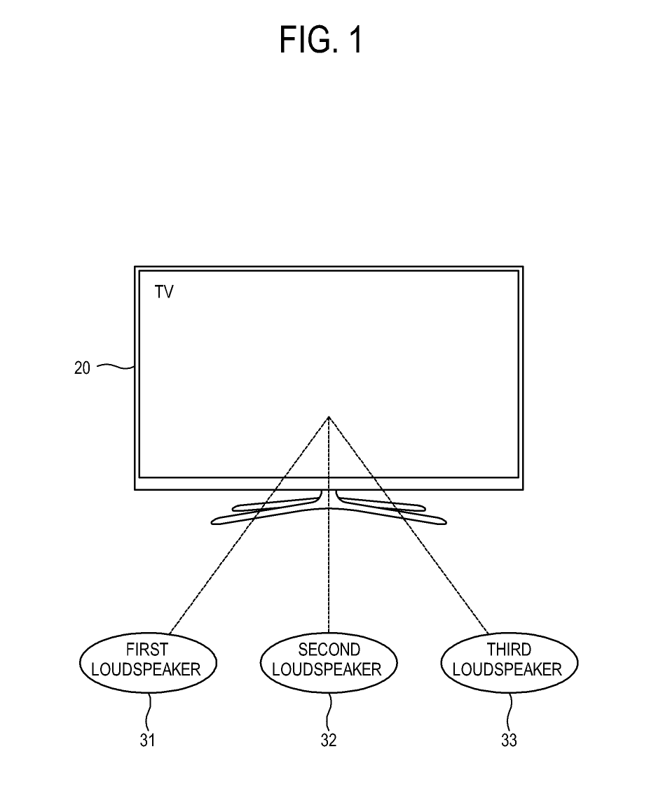

FIG. 2 is a view showing a layout of an electronic apparatus and a peripheral device to explain a method of calculating an angular position of the peripheral device according to a first exemplary embodiment.

FIG. 3 is a block diagram of the peripheral device in FIG. 2.

FIG. 4 is a flowchart of calculating the angular position of the peripheral device, performed between the electronic apparatus and the peripheral device of FIGS. 2 and 3.

FIG. 5 is a view of showing a hyperbola and its asymptote to explain a principle of calculating an angular position of a peripheral device according to an exemplary embodiment.

FIG. 6 is a view showing an example of a matching table stored in a storage of the peripheral device of FIG. 3.

FIG. 7 is a view of another exemplary embodiment of FIG. 6.

FIG. 8 is a view of an alternative example of FIG. 3.

FIG. 9 is a view of an alternative example of FIG. 4 corresponding to the alternative example of FIG. 3.

FIG. 10 is a view showing a layout of an electronic apparatus and a peripheral device to explain a method of calculating an angular position of the peripheral device according to a second exemplary embodiment.

FIG. 11 is a block diagram of the peripheral device in FIG. 10.

FIG. 12 is a block diagram of the electronic apparatus in FIG. 10.

FIG. 13 is a flowchart of calculating the angular position of the peripheral device, performed between the electronic apparatus and the peripheral device of FIGS. 10 to 12.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

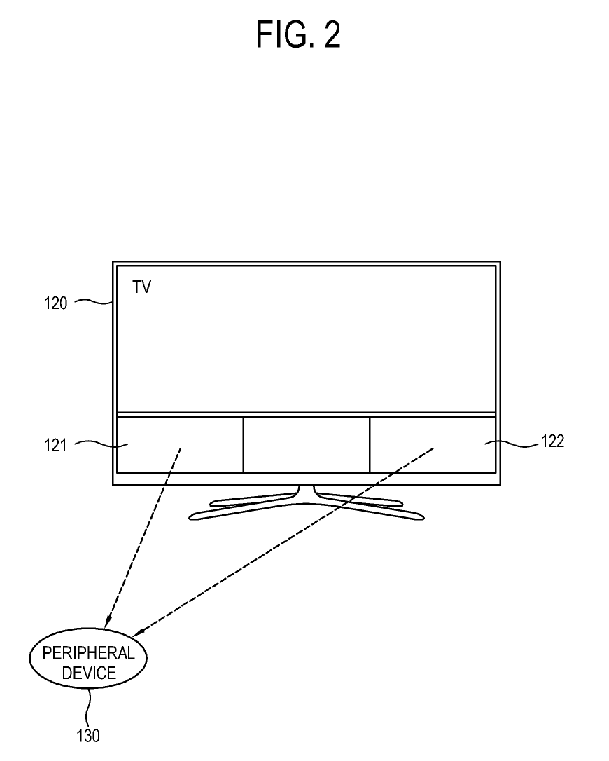

FIG. 2 is a view showing a layout of an electronic apparatus and a peripheral device to explain a method of calculating an angular position of the peripheral device according to a first exemplary embodiment. According to an exemplary embodiment, a television (TV) will be described as an example of an electronic apparatus 120 that has at least two loudspeakers 121 and 122. Typically, the TV includes two loudspeakers at left and right sides of a main body, respectively. In the exemplary embodiment, a peripheral device 130 may be a remote controller or a loudspeaker as described in the foregoing related art, or may be other devices that need to know their positions. According to an exemplary embodiment, to calculate the angular position of the peripheral device 130, a function is needed for receiving sounds generated by the loudspeakers 121 and 122 provided in the electronic apparatus 120.

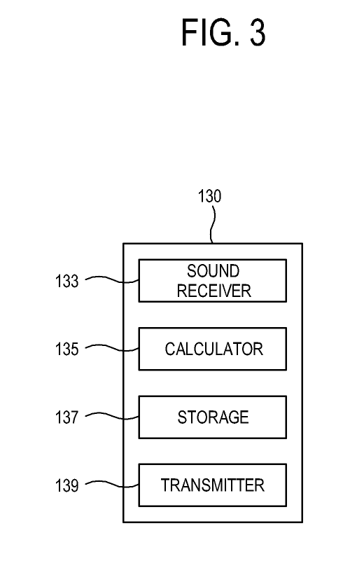

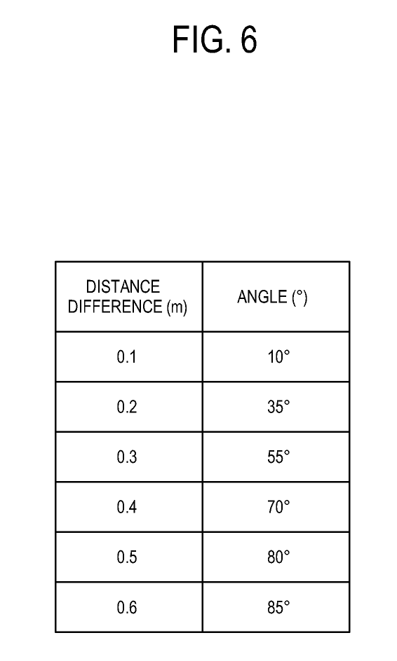

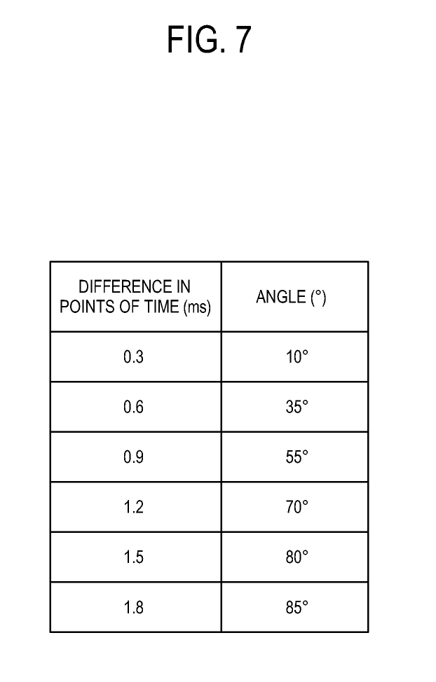

FIG. 3 is a view illustrating exemplary elements, for achieving the present exemplary embodiment, among the elements of the peripheral device in FIG. 2. As shown in FIG. 3, the peripheral device 130 includes a sound receiver 133, a calculator 135, including, for example, a hardware processor, a storage 137, and a transmitter 139. The sound receiver 133 receives a sound from the loudspeakers 121 and 122 of the electronic apparatus 120. The calculator 135 calculates a relative angular position of the peripheral device 130 with respect to the electronic apparatus 120, based on the sound received in the sound receiver 133. The storage 137 stores data to be referred to by the calculator 135 to calculate the angular position, and specifically includes matching tables as shown in FIG. 6 or 7. The transmitter 139 transmits the calculated angular position to the electronic apparatus 120.

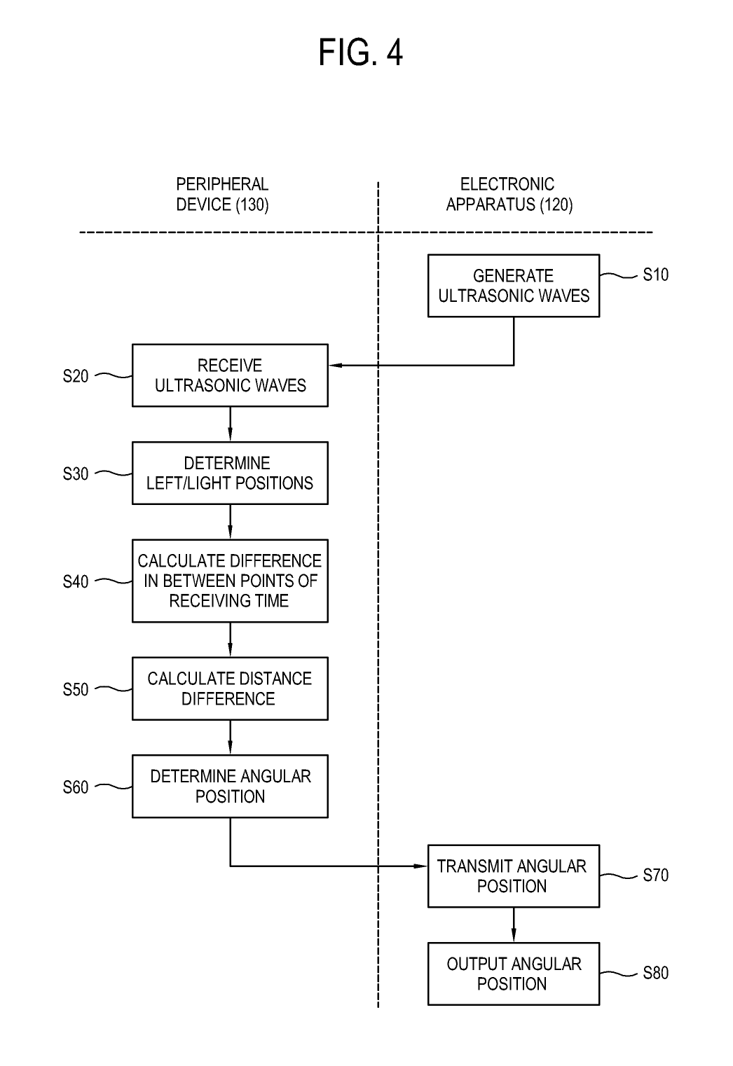

FIG. 4 is a flowchart of calculating the angular position of the peripheral device 130, performed between the electronic apparatus 120 and the peripheral device 130 of FIGS. 2 and 3. To perform the method of calculating the angular position according to an exemplary embodiment, the electronic apparatus 120 and the peripheral device 130 may be previously paired. Below, the stages shown in FIG. 4 are described.

Stage S10

The electronic apparatus 120 generates sounds using the loudspeakers 121 and 122. The sounds of the two loudspeakers 121 and 122 may be generated simultaneously.

The sound may be produced just for calculating the angular position of the peripheral device 130, and thus may be inaudible to a user. Therefore, a sound having a frequency beyond an audio frequency range of a human, e.g. an ultrasonic sound having a frequency of 20,000 Hz is generated. Thus, the angular position of the peripheral device is calculated under a more comfortable environment for a user since they cannot recognize a sound used in calculating the angular position of the peripheral device 130. In the case where the ultrasonic sound is used, the lower limit of the available frequency may be the upper limit of the audio frequency, for example, 16,000 Hz and the upper limit may be a frequency that can be not only generated by the loudspeakers 121 and 122 but also recognized by the sound receiver 133 of the peripheral device 130.

Further, the sound includes identification signals of the respective loudspeakers 121 and 122. For example, if the sounds generated by the loudspeakers 121 and 122 are represented in the form of data, the left loudspeaker 121 generates data of “0010” and the right loudspeaker 122 generates data of “0011”. “0010” refers to data of indicating the left loudspeaker 121, and “0011” refers to data of indicating the right loudspeaker 122. Information about such an identification signal may be previously transmitted from the electronic apparatus 120 to the peripheral device 130, or may be previously input as setting values to the peripheral device 130 by the manufacturer of the peripheral device 130. Therefore, the peripheral device 130 previously knows the information.

Stage S20

When a sound generated by the electronic apparatus 120 reaches the peripheral device 130, the peripheral device 130 receives the sound in its sound receiver 133. The sound receiver 133 may include a typical microphone. Further, the sound receiver 133 may include a converter for converting the sound received in the microphone into data, for example an analog/digital (A/D) converter. Since the sound received in the microphone is converted into the data by the converter, the peripheral device 130 can determine whether the received sound includes the identification signal of each of the loudspeakers 121 and 122.

Stage S30

The calculator 135 starts calculating the angular position of the peripheral device 130 based on the received sound as the sound is received in the sound receiver 133. To calculate the angular position, the calculator 135 first determines which side the peripheral device 130 is positioned between the left side and the right side with respect to the electronic apparatus 120.

That is, if the identification signals of “0010” and “0011” from the respective loudspeakers 121 and 122 are detected in the stage S20, the calculator 135 determines an order of these signals by comparing points of time when the signals are respectively received. If “0010” is detected earlier than “0011”, it indicates that the sound from the left loudspeaker 121 arrives at the sound receiver 133 before the sound from the right loudspeaker 122. In the case, the peripheral device 130 is positioned closer to the left loudspeaker 121 than the right loudspeaker 122, the calculator 135 determines that the peripheral device 130 is positioned on the left side with respect to the frontward direction of the electronic apparatus 120.

A peripheral device 130 determines from which of the loudspeakers 121 and 122 the sound arrives first, and thus determines whether the peripheral device 130 is positioned on the left or right side with respect to the frontward direction of the electronic apparatus 120.

Stage S40

The calculator 135 calculates difference between points of time when the sounds from the loudspeakers 121 and 122 arrive. The calculation of the time difference may be achieved by using time of a separate timer (not shown) provided in the peripheral device 130. That is, the timer measures the respective points of time when the signals of “0010” and “0011” are received in the sound receiver 133, and calculates the difference between the two detected points of time. Thereby calculating difference between the arriving points of time. Further, the difference between the arriving points of time may be calculated based on the number of sampling cycles in the converter. For example, in a case where the A/D converter for converting the received sound into data has a sampling cycle of 10 μs, if “0011” is detected after a lapse of 50 sampling cycles from the detection of “0010”, it is calculated that the sound generated in the left loudspeaker 121 is received in the sound receiver 133 earlier by 0.5 ms than the signal from the right loudspeaker 121.

Stage S50

The calculator 135 calculates a distance difference based on the difference between the points of time calculated in the stage S40. A distance difference refers to difference between a distance from the peripheral device 130 to the left loudspeaker 121 and a distance from the peripheral device to the right loudspeaker 122. Assuming that the sound has a speed of 340 m/s, if the difference between the points of time calculated in the stage S40 is 0.5 ms, the distance difference is 0.17 m.

Stage S60

The calculator 135 determines the angular position based on the distance difference calculated in the stage S50. The angular position refers to an angle between the peripheral device 130 and a horizontal plane with respect to the frontward direction of the electronic apparatus 120. In the exemplary embodiment, the angular position is calculated using a method of calculating an angle of an asymptote of a hyperbola.

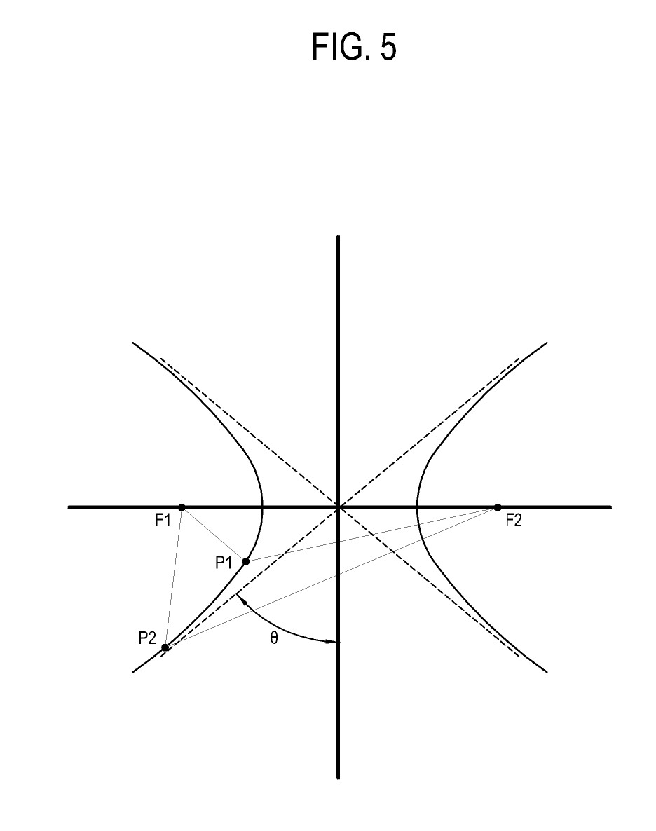

FIG. 5 is a view of showing a hyperbola and its asymptote to explain a principle of calculating an angular position of a peripheral device according to an exemplary embodiment. The hyperbola is defined as “a set of points, where differences in distance from two points are constant.” The two points refers to the focal points F1 and F2 of the hyperbola on a coordinate plane, and the distance difference refers to a difference in distances between a certain point P1 on the hyperbola and two focal points, i.e. between a distance from F1 to P1 and a distance from F2 to P1. The constant distance difference on the hyperbola indicates that a distance difference at a point P1 is equal to a distance difference at another point P2.

The positions of the two focal points F1 and F2 on the hyperbola of FIG. 5 correspond to the positions of the two loudspeakers 121 and 122, and the distance difference of the hyperbola corresponds to the distance difference calculated in the stage S50. Therefore, if the distance between the two loudspeakers 121 and 122 of the electronic apparatus 120 is given, it is possible to determine the positions of F1 and F2. For example if the distance between the two loudspeakers 121 and 122 of the electronic apparatus 120 is 0.6, the coordinates of the left loudspeaker 121 and the right loudspeaker 122 are respectively determined as (−0.3, 0) and (0.3, 0).

If the coordinates of the two focal points F1 and F2 are determined and the distance difference calculated in the stage S50 is designated as the distance difference of the hyperbola, the hyperbola is formed as shown in FIG. 5. Considering the hyperbola, asymptotes are straight lines like dotted lines as shown in FIG. 5. Since the equation of the asymptote is well-known, detailed descriptions will be omitted regarding a method of obtaining the asymptotes of the hyperbola when the focal points and the distance difference are given. In FIG. 5, the x-axial direction is parallel with the front surface of the electronic apparatus 120, and the y-axial direction is perpendicular to the front surface of the electronic apparatus 120, in which the frontward direction of the electronic apparatus 120 is the (−y)-axial direction.

Since the asymptote is a line that passing through the origin on the coordinate plane, for example, if the horizontal axis of FIG. 5 is an x-axis and a vertical axis is an y-axis, the asymptote is represented by the equation (1) of

x=ky Equation (1)

where k is a gradient of the asymptote with respect to the y axis.

The angle to the frontward direction of the electronic apparatus 120 corresponds to θ in FIG. 5, and a is obtained by the following equation (2).

θ=tan⁻¹k Equation (2)

If the distance between the two loudspeakers 121 and 122 and the distance difference calculated in the stage S50 are given, it is possible to calculate the angular position of the peripheral device 130 with respect to the frontward direction of the electronic apparatus 120 by the equation of obtaining the angle of the asymptote of the hyperbola.

The calculator 135 calculates the angular position, for example, by the foregoing method of obtaining the angle of the asymptote of the hyperbola, based on the information about the distance between the two loudspeakers 121 and 122 and the distance difference calculated in the stage S50.

The angle of the asymptote of the hyperbola may be slightly different from an actual angle at a certain point on the hyperbola with respect to the origin. The closer to the origin, the larger the difference. The farther away from the origin, the smaller the difference. Therefore, if the peripheral device 130 is very close to the electronic apparatus 120, there may be a large error between the calculated angular position and the actual angular position. However, for example, if the remote controller is very close to the electronic apparatus 120, such an error may be ignorable since a user is not likely to lose the remote controller and is easy to find the remote controller. Further, the angular position of the peripheral device 130 may be for example calculated to be a little greater than the angle of the asymptote, so that the error can be canceled by correction when the final angular position is calculated.

The calculator 135 may use a matching table, for example, as shown in FIG. 6 so as to calculate the angular position, instead of performing the foregoing processes in sequence or putting the results from the foregoing processes in the equation.

FIG. 6 shows a matching table of a database obtained by calculating the angles of the asymptote according to the plurality of distance differences, in which data about the matching table is previously stored in the storage 137. The matching table of FIG. 6 may be tabulated by previously calculating the distance difference between the two loudspeakers 121 and 122 and the corresponding angles. FIG. 6 does not show information about the distance between the two loudspeakers 121 and 122 corresponding to the information about the focal points of the hyperbola. This is based on assumption that the information about the distance between the loudspeakers 121 and 122 the electronic apparatus 120 is not variable but constant, i.e. the peripheral device 130 may be attached to the electronic apparatus 120. Therefore, the electronic apparatus 120 may have various differences between the loudspeakers 121 and 122 in accordance with its models. Therefore, the matching table shown in FIG. 6 may be varied depending on the models of the electronic apparatus 120. If the peripheral device 130 is not attached to a certain electronic apparatus 120 and manufactured as a separate independent product to be universally used for many electronic apparatuses 120, the matching table may have to be tabulated as shown in FIG. 6 by setting the distance between the two loudspeakers 121 and 122, for example, from 30 cm to 1 m at intervals of 5 cm.

Such a matching table may be previously prepared and stored in the storage 137 of the peripheral device 130. When the distance difference is calculated in the stage S50, the calculator 135 looks up the angle corresponding to the calculated distance difference in the matching table of the storage 137. For example, if a distance difference of 0.3 m is calculated, an angle of 55° is determined in the matching table of FIG. 6.

FIG. 7 is a view of another exemplary embodiment of FIG. 6. FIG. 7 shows a matching table in which time differences are tabulated according to the angles.

The difference between the points of time may be detected in the stage S40, and the distance difference is calculated based on the calculated difference between the points of time in the sag S50. To implement the foregoing method using the asymptote of the hyperbola, there is a need of information about the distance difference for mathematically drawing a hyperbola. However, speed of sound in air is constant within an error range allowable in calculating the angular position, and thus the information about the difference between the points of time calculated in the stage S40 is equivalent to the information about the distance difference. Therefore, the result is the same regardless of whether the distance difference calculated in the stage S50 or the difference between the points of time calculated in the stage S40 is used as a variable in the method of using the matching table of FIG. 6. In this case, there is no need of converting the difference between the points of time into the distance difference in the stage S50, and the calculator 135 can extract the angular position by looking up the difference between the detected points of time in the matching table of the storage 137.

In the alternative example of FIG. 7, a plurality of matching tables may be tabulated with regard to various distances between the loudspeakers 121 and 122 since the distance between the loudspeakers 121 and 122 is varied depending on the models of the electronic apparatus 120.

The angular position in this embodiment is an angular position on a plane including the pair of loudspeakers 121 and 122, more specifically a plane including the pair of loudspeakers 121 and 122 and the peripheral device 130. This is because the positions of the pair of loudspeakers 121 and 122 are defined as the focal points of the hyperbola and the distance differences between the peripheral device 130 and the respective loudspeakers 121 and 122 are defined as the distance difference of the hyperbola. Therefore, if the peripheral device 130 is placed at the same height as the loudspeakers 121 and 122, the angular position is an angular position on a horizontal plane. However, if the peripheral device 130 is higher or lower than the loudspeakers 121 and 122, the angular position may be an angular position on a plane a little inclined from the horizontal plane. Therefore, in some cases, the calculated angular position may be an angular position of an unexpected direction in view of a user. However, in consideration of an expected application field, such an error is within an allowable range and does not make a trouble except that the peripheral device is extremely placed directly above the electronic apparatus 120 or the like circumstances.

Further, as described above, there may be an error between the angle of the asymptote and the actual angular position of the peripheral device 13. Such an error increases as the peripheral device 130 gets closer to the electronic apparatus 120. Therefore, if the results from using the asymptote of the hyperbola are given in the form of the matching table as shown in FIG. 6 or 7, the values of the actual angular positions may be corrected little by little by reflecting an error between the hyperbola and the asymptote when data is individually tabulated.

Stage S70

The transmitter 139 of the peripheral device 130 transmits the information about the angular position calculated by the calculator 135 to the electronic apparatus 120. The transmitter 139 may be achieved by various apparatuses, for example, capable of performing data communication with the electronic apparatus 120, and may for example include an infrared transmitter, a Bluetooth transmitter, and other wired/wireless data interfaces, etc.

Stage S80

The electronic apparatus 120 outputs the received information about the angular position. The output may be achieved visually or audibly. If the electronic apparatus 120 includes a display, a message of “the remote controller is placed at an angle of 30° in a left direction of the TV” or an image schematically showing the positions of the TV and the remote controller may be displayed by way of example. In case of outputting the information audibly, such a message is output as a sound through the loudspeakers 121 and 122.

The electronic apparatus 120 may change subsidiary settings based on the received angular position. For example, if the peripheral device 130 is the loudspeaker, the foregoing processes are repeated with respect to each loudspeaker so that the angular positions of the plurality of loudspeakers can be input to the electronic apparatus 120. In this case, the input positions of the loudspeakers are values of the settings of the electronic apparatus 120, so that the electronic apparatus 120 can reproduce a sound taking the position of each loudspeaker into account when it reproduces the sound in the future, thereby reproducing a more optimized sound.

If the peripheral device 130 is the remote controller and the present inventive concept is applied to find the remote controller about which a user has forgotten where they put it, the foregoing processes may be performed when a user controls the electronic apparatus 120. For example, a separate button of “find the remote controller” is provided on a control panel of the electronic apparatus 120, and thus the foregoing processes are implemented when a user presses this button. If a user does not know where the remote controller is and thus presses the foregoing button, the TV displays guide information about the direction of the remote controller. Accordingly, a user can easily find the position where the remote controller is.

In the foregoing exemplary embodiments, the pair of loudspeakers 121 and 122 of the electronic apparatus 120 are placed at the same position in the horizontal direction, i.e. at the same height. Alternatively, even if two loudspeakers are placed at different positions in a vertical direction, the same method may be used to calculate angular positions in the vertical direction.

Further, if the angular positions of the two loudspeakers placed at the same position in the horizontal direction and the angular positions of the two loudspeakers placed at the same position in the vertical direction are both calculated, it is possible to calculate the distance from the electronic apparatus 120 to the peripheral device 130 by triangulation or the like method.

In the foregoing exemplary embodiment, the peripheral device 130 detects the difference between the points of time based on the received sounds and then calculates the angle. Alternatively, the peripheral device 130 may detect the difference between the points of time and transmit the difference between the detected points of time to the electronic apparatus 120, and the electronic apparatus 120 may implement the following processes (stages S30 to S60) of calculating the angular position based on the received difference between the points of time. The peripheral device 130 transmits the difference between the points of time to the electronic apparatus 120 indicates that the peripheral device 130 transmits not only the difference, itself, between the points of time but also information needed for calculating at least the difference between the points of time to the electronic apparatus 120. For example, the peripheral device 130 may send only the information about the points of time respectively received from the two loudspeakers 121 and 122, or only the information about the number of sampling cycles in the A/D converter between the respective points of time at which the identification signals are detected with regard to the sounds from the two loudspeakers 121 and 122. The electronic apparatus 120 can calculate the difference between the points of time based on the information received from the peripheral device 130.

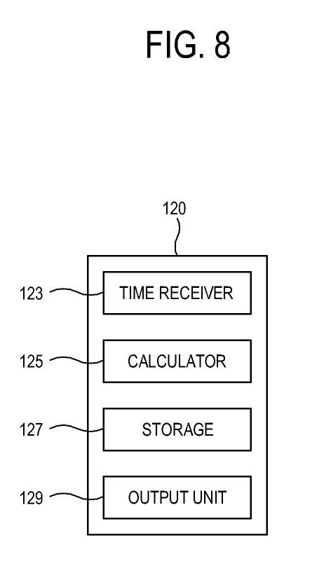

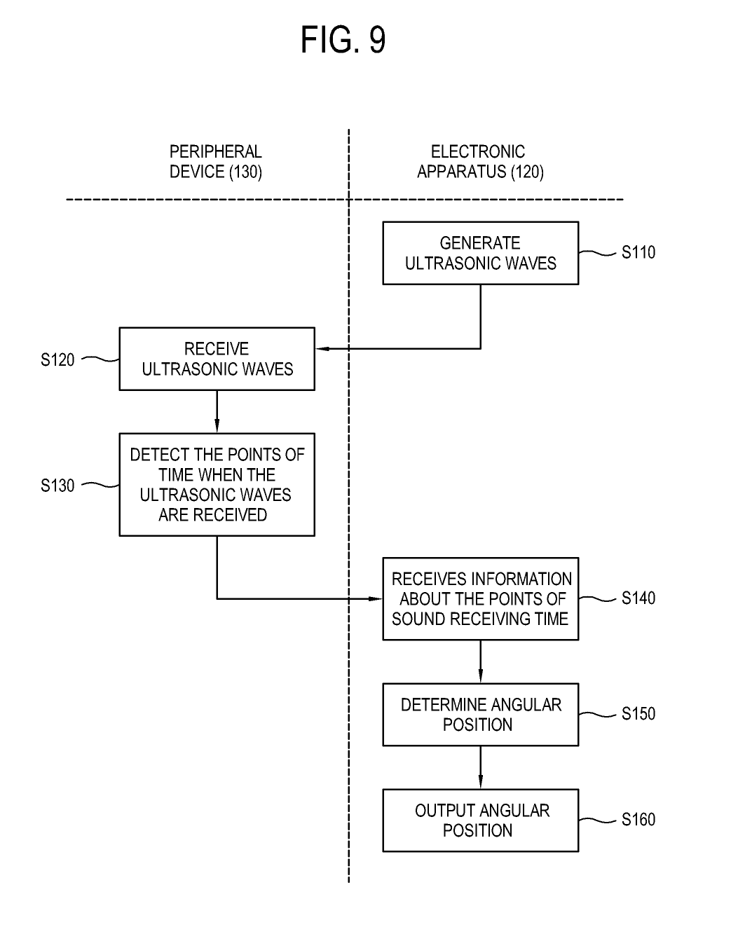

FIG. 8 shows the elements of the electronic apparatus 120 for performing such an alternative example, and FIG. 9 shows an alternative process performed by the electronic apparatus 120 of FIG. 8 and the peripheral device 130.

As shown in FIG. 8, the electronic apparatus 120 includes a time receiver 123, a calculator 125, a storage 127 and an output unit 129. The time receiver 123 receives information about the time from the peripheral device 130. The time information refers to information about time at which sound signals from the two loudspeakers 121 and 122 of the electronic apparatus 120 are received in the sound receiver 133 of the peripheral device 130. The calculator 125 and the storage 127 may be substantially the same as the calculator 135 and the storage 137 of the peripheral device 130 shown in FIG. 3, and perform the same processes. The output unit 129 outputs the angular position calculated by the electronic apparatus 120, and may be achieved by a display or loudspeakers 121 and 122 provided in the TV.

As shown in FIG. 9, if the electronic apparatus 120 generates ultrasonic waves (S110), the ultrasonic waves are received in the peripheral device 130, the peripheral device 130 detects the points of time when the ultrasonic waves are received (S130) and transmits it to the electronic apparatus 120. According to this exemplary embodiment, the peripheral device 130 may have only the sound receiver 133 and the transmitter 139 among the elements of FIG. 3.

The electronic apparatus 120 receives information about the points of sound receiving time in the two loudspeakers 121 and 122 from the peripheral device 130 through the time receiver 123 (S140), and determines the angular position based on the received time information (S150). In the stage S150, the angular position is determined by the same method as described in the stages S30 to S60 of the foregoing embodiment shown in FIG. 4. The electronic apparatus 120 outputs the determined angular position as an image on a screen or a sound through the loudspeakers 121 and 122 (S160).

According to this alternative example of FIGS. 8 and 9, there is an advantage that the structure of the peripheral device 130 becomes simpler. Further, the electronic apparatus 120 usually includes hardware components of which performance is higher than those of the peripheral device 130. Thus, it may be easier for the electronic apparatus 120 to realize the present inventive concept by software modification with respect to the existing hardware components.

In the first exemplary embodiment, the peripheral device 130 receives a sound. Alternatively, if the peripheral device 130 includes the loudspeaker, the peripheral device 130 may generate a sound (preferably ultrasonic waves) and the electronic apparatus 120 may receive the sound. In this case, the electronic apparatus 120 has to include two or more microphones for receiving the sound from the peripheral device 130, in which the positions of the pair of microphones are regarded as focal points of a hyperbola and a distance difference converted from a difference between points of time when the microphones receive the sound is regarded as a distance difference in the hyperbola.

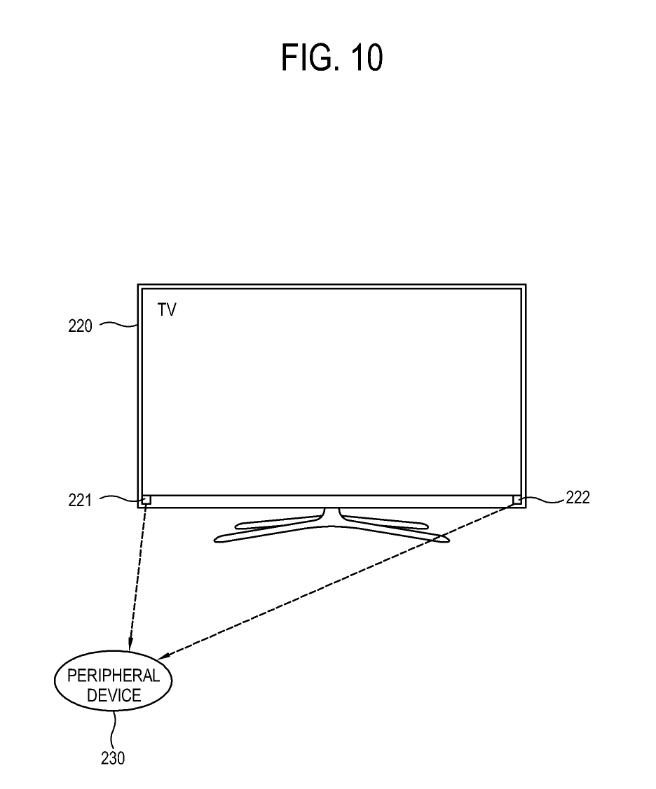

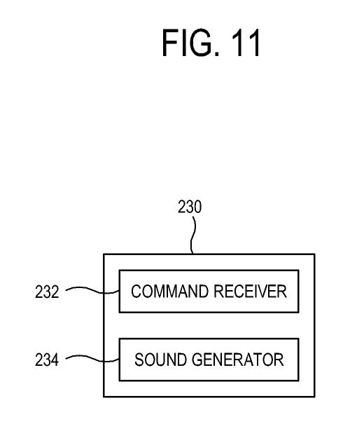

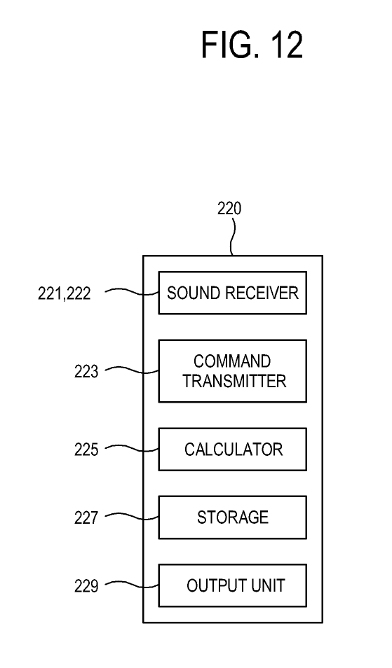

FIGS. 10 to 13 are views of a second exemplary embodiment, in which FIG. 10 is a view showing a layout of an electronic apparatus and a peripheral device, and FIGS. 11 and 12 are block diagrams showing the elements of the peripheral device and the electronic apparatus, respectively.

Elements shown in FIG. 10 are similar to those of the first exemplary embodiment shown in FIG. 2. However, an electronic apparatus 220 according to an exemplary embodiment may, for example, include two sound receivers 121 and 122 such as microphones or the like.

As shown in FIG. 11, the peripheral device 230 includes a command receiver 232 and a sound generator 234. The command receiver 232 receives a sound making command from the electronic apparatus 220, and the sound generator 234 generates a sound in response to the sound making command received in the command receiver 232.

As shown in FIG. 12, the electronic apparatus 220 includes the sound receivers 221 and 222, a command transmitter 223, a calculator 225, a storage 227 and an output unit 229. The sound receivers 221 and 222 are achieved by the microphones or the like as described above, and receives the sound generated by the sound generator 234 of the peripheral device 232. The command transmitter 223 transmits the sound making command to the peripheral device 230. The calculator 225, the storage 227 and the output unit 229 perform substantially the same operation as the calculator 125, the storage 127 and the output unit 129 of FIG. 8.

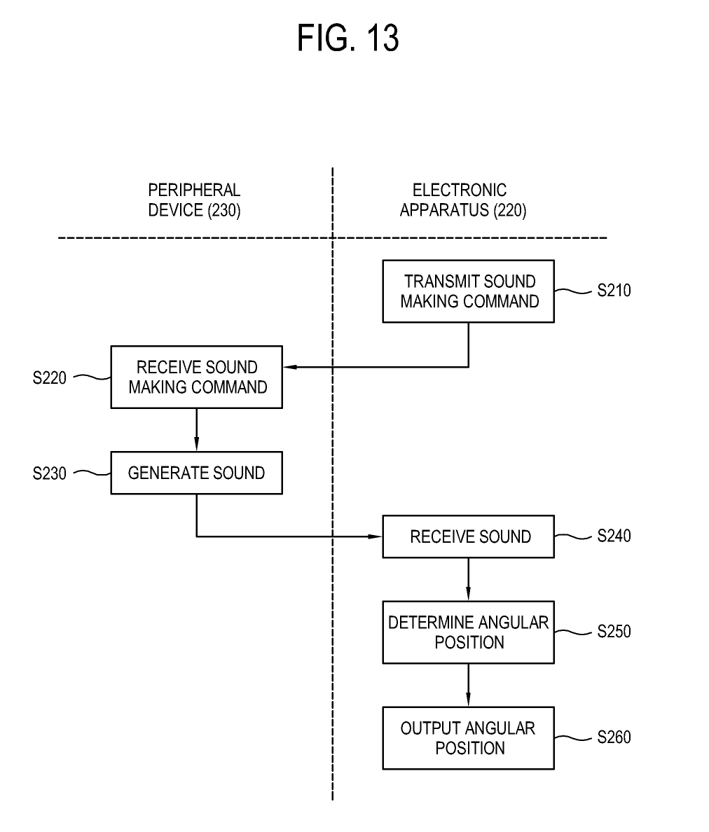

FIG. 13 is a flowchart of calculating the angular position of the peripheral device according to the second exemplary embodiment, performed between the electronic apparatus and the peripheral device of FIGS. 10 to 12.

First, the command transmitter 223 of the electronic apparatus 220 transmits a command for making a request for a sound to the peripheral device 230 (S210), and the peripheral device 230 receives the sound making command through the command receiver 232 (S220). The command receiver 232 sends the sound making command to the sound generator 234, and thus the sound generator 234 generates a sound, preferably the ultrasonic waves (S230). The generated sound is received in the sound receivers 221 and 222 of the electronic apparatus 220 (S240).

When the electronic apparatus 220 receives the sound, the electronic apparatus 220 determines the angular position of the peripheral device 230 based on the received sound (S250). At this time, the process of calculating and determining the angular position by the calculator 225 is substantially the same as that of the first exemplary embodiment. In contrast to the first exemplary embodiment, the positions of the two sound receivers 221 and 222 may be used as the focal points of the hyperbola. The calculator 225 calculates the angular position of the peripheral device 230 with respect to the electronic apparatus 220 on the plane including two positions, based on the difference between the points of time when the respective sound receivers 121 and 122 receive the signals generated by the peripheral device 230. The calculator 225 may extract the angular position from the storage 227 previously storing the matching table using the asymptote of the hyperbola.

The electronic apparatus 220 outputs the angular position determined as above to the output unit 229 (S260).

According to the second exemplary embodiment, the peripheral device 230 does not have to include the storage 137, the transmitter 139 and the like as shown in FIG. 3, and therefore advantageously may have a simpler structure than that of the first exemplary embodiment. Thus, an exemplary embodiment may be applied to an existing peripheral device. If a peripheral device 230 is the loudspeaker, it may be possible to use the existing loudspeaker without separately adding the sound generator 234. According to an exemplary embodiment, the electronic apparatus 230 does not have to add a separate identification signal to the sound since it can identify its' own sound receivers 221 and 222.

In addition, the stages S210 and S220 may be omitted in the second exemplary embodiment. If a user manually controls the peripheral device 230 to make the sound generator 234 generate a sound under the condition that the electronic apparatus 220 is ready for calculating the angular position (S230), the electronic apparatus 220 receives the sound through the sound receivers 221 and 222 and thus performs the stages S240 and S250 for calculating the angular position and the stage S260 for outputting the calculated angular position.

If the stages S210 and S220 are omitted, the electronic apparatus 220 does not have to separately include the command transmitter 223 and the peripheral device 230 does not have to separately include the command receiver 232. Therefore, it is possible to decrease modification needed for applying the present inventive concept to an existing peripheral device.

Exemplary embodiments of the present invention include advantages as follows.

First, the angular position of the peripheral device 130 may be automatically determined with respect to the electronic apparatus 120 and then provided to the electronic apparatus 120. Therefore, it is possible to apply the present inventive concept to various fields, for example, the position auto-setting of the loudspeakers with respect to the TV, finding the lost remote controller, etc., thereby offering convenience to a user.

Second, the sound signal may be used as a medium for determining the angular position of the peripheral device 130. Since all the electronic apparatuses such as home appliances include the loudspeaker such as at least an alarming loudspeaker, modification of only software is enough to apply the present inventive concept to all the apparatus without adding hardware to the existing hardware. In a particular case of using ultrasonic waves, it is more convenient for a user since they are not exposed to an unnecessary audible sound.

Third, it is very simple to calculate the angular position. According to an embodiment, only detecting the difference between the points of time taken in making the sound from the two loudspeakers 121 and 122 arriving at the peripheral device 130 may be needed. Further, the calculation is very simple since the angle of the asymptote of the hyperbola may be calculated as the angular position. instead of a process of calculating the angle of the asymptote by concretely drawing the hyperbola with respect to the calculated difference between the points of time, the matching table obtained by the same calculating process is previously prepared, and it is thus possible to omit the calculating process.

Fourth, the method of calculating the angular position according to an exemplary embodiment may be optimized to determine a position of a peripheral device of a general electronic apparatus, such as a home appliance, having a proper size and installed in a room. For example, a positioning system using a global positioning system (GPS) requires not only a very precise and complicated calculation method since a position of an object is determined using a signal received from a long distance between a satellite and the surface of the earth, but also has to satisfy difficult conditions that a transmission signal is little affected by surrounding environments and so on. Therefore, it may be difficult for this positioning system to use a sound according to the exemplary embodiment as a signal. Further, this positioning system may not be allowed to use the asymptote of the hyperbola in calculating the angle due to an excessive error.

In contrast to a typical positioning system employed for ultimately calculating a position on coordinates, the present inventive concept may be provided to only calculate the angular position and thus performs a simple calculation method. In a case of setting or determining a position of a peripheral device in a room, determination of only an angular position may be enough to satisfy a corresponding purpose.

As described above, the present inventive concept may automatically determine an angular position of a peripheral device with respect to an electronic apparatus. Thus, the present inventive concept may be applicable to various fields. For example, it may be possible to automatically set the positions of the loudspeaker with respect to the TV, find the lost remote controller, and so on.

The present inventive concept employs a sound signal as a medium for determining the angular position of the peripheral device, and is therefore applicable to most of electronic apparatuses, for example, without adding hardware components.

Further, the present inventive concept has a very simple method of calculating the angular position, and it may be possible to obtain the angular position by looking up the database of the matching table without calculation.

The present inventive concept provides a method optimized, for example, to determine the position of the peripheral device of the electronic apparatus such as home appliances having a proper size and installed in a room.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A method of calculating an angular position of a peripheral device with respect to an electronic apparatus, the method comprising:
receiving sounds, by the peripheral device, from each of a pair of loudspeakers provided in the electronic apparatus; and
calculating, by the peripheral device, an angular position of the peripheral device with respect to a predetermined direction, based on a difference between respective points of time in receiving the sounds from each loudspeaker.

2. The method according to claim 1, wherein the sound comprises ultrasonic waves.

3. The method according to claim 1, wherein the sound comprises an identification signal of each loudspeaker.

4. The method according to claim 1, wherein the calculating the angular position comprises calculating the angular position based on an angle of an asymptote of a hyperbola formed by defining positions of the pair of loudspeakers as positions of a pair of focal points and a distance corresponding to a difference between the points of receiving time as a distance difference.

5. The method according to claim 4, wherein the peripheral device comprises a matching table of a database where angles of the asymptote are previously tabulated corresponding to a plurality of the distance differences or a plurality of the differences between the points of receiving time.

6. The method according to claim 1, further comprising transmitting, by the peripheral device, the calculated angular position to the electronic apparatus.

7. The method according to claim 6, further comprising outputting, by the electronic apparatus, information about the angular position.

8. A peripheral device capable of calculating a relative angular position of the peripheral device with respect to an electronic apparatus, the peripheral device comprising:
a sound receiver configured to receive sounds from each of a pair of loudspeakers provided in the electronic apparatus; and
a calculator including a hardware processor configured to calculate an angular position with respect to a predetermined direction based on a difference between respective points of time in receiving the sounds from each loudspeaker in the sound receiver.

9. The peripheral device according to claim 8, wherein the sound comprises ultrasonic waves.

10. The peripheral device according to claim 8, wherein the sound comprises an identification signal of each loudspeaker.

11. The peripheral device according to claim 8, wherein the calculator calculates the angular position based on an angle of an asymptote of a hyperbola formed by defining positions of the pair of loudspeakers as positions of a pair of focal points and a distance corresponding to the difference between the points of receiving time as a distance difference.

12. The peripheral device according to claim 11, further comprising a storage configured to comprise a matching table of a database where the angles of the asymptote are previously tabulated corresponding to a plurality of the distance differences or a plurality of the differences between the points of receiving time,
wherein the calculator looks up the matching table to determine the angular position.

13. The peripheral device according to claim 8, further comprising a transmitter configured to transmit the angular position to the electronic apparatus.

14. A method of calculating an angular position of a peripheral device with respect to an electronic apparatus, the method comprising:
receiving, by the electronic apparatus, sounds in at least two positions from the peripheral device; and
calculating, by the electronic apparatus, an angular position of the peripheral device with respect to a predetermined direction, based on a difference between respective points of time taken in receiving the sounds in the at least two positions.

15. The method according to claim 14, wherein the sound comprises ultrasonic waves.

16. The method according to claim 14, wherein the calculating the angular position comprises calculating the angular position based on an angle of an asymptote of a hyperbola formed by defining positions of the pair of loudspeakers as positions of a pair of focal points and a distance corresponding to the difference between the points of receiving time as a distance difference.

17. The method according to claim 16, wherein the electronic apparatus comprises a matching table of a database where the angles of the asymptote are previously tabulated corresponding to a plurality of the distance differences or a plurality of the differences between the points of receiving time.

18. The method according to claim 14, further comprising: by the electronic apparatus, outputting information about the angular position.

19. An electronic apparatus capable of calculating an angular position of a peripheral device, the electronic apparatus comprising:
a pair of sound receivers configured to be respectively arranged at different positions; and
a calculator including a hardware processor configured to calculate the angular position with respect to a predetermined direction of the peripheral device, based on a receiving time difference between respective points of time taken in receiving sounds in each of the sound receivers.

20. The electronic apparatus according to claim 19, wherein the sound comprises ultrasonic waves.

21. The electronic apparatus according to claim 20, wherein the calculator calculates the angular position based on an angle of an asymptote of a hyperbola formed by defining positions of the pair of loudspeakers as positions of a pair of focal points and a distance corresponding to the difference between the points of receiving time as a distance difference.

22. The electronic apparatus according to claim 21, further comprising a storage configured to comprise a matching table of a database where the angles of the asymptote are previously tabulated corresponding to a plurality of the distance differences or a plurality of the differences between the points of receiving time,
wherein the calculator looks up the matching table to determine the angular position.

23. The electronic apparatus according to claim 19, further comprising an output unit to output information about the calculated angular position.
